(19) United States
(12) Patent Application Publication
(10) Pub. No.: US 2026/0188071 A1
(43) Pub. Date: Jul. 2, 2026

(54) CASH RECYCLER POCKET COVER, PUSHER PLATE AND STACKING LEVER SYSTEM AND METHOD

(71) Applicant: Cardtronics USA, Inc., Atlanta, GA (US)

(72) Inventors: Jamie Kenneth Stewart, Dundee (GB); Zelin Liu, Monifieth (GB); Scott Low Colston, Dundee (GB); Matthew Bowen, Perth (GB); Callum Jacklin, Dundee (GB)

(21) Appl. No.: 19/006,336

(22) Filed: Dec. 31, 2024

(51) Int. Cl. G07D 11/18; B65H 29/58; B65H 31/34; G07D 11/14; G07D 11/50

(52) U.S. Cl. CPC G07D 11/14; G07D 11/165; G07D 11/18; B65H 2701/1912; G07D 2211/00

(57) ABSTRACT

An automatic teller machine and associated methods are disclosed. In one example, a device may include a pusher plate, wherein the pusher plate is moveable up and down within the pocket in the range of motion, wherein the pusher plate is integrally formed, and includes a cutout in a front portion to accommodate grasping stacked bank notes from below the cutout. A device may include a stacking lever in a front portion of a top compartment, the stacking lever including a plurality of integrally formed fingers connected at an integrally formed lower edge.

### TECHNICAL FIELD

Embodiments described herein generally relate to automatic teller machines and associated methods. Specific embodiments described herein relate to recycling automatic teller machines and configurations related to a slot for receiving bank notes.

### BACKGROUND

Automated Teller Machines (ATMs) have become an integral component of modern banking, enabling customers to perform a variety of transactions, including cash withdrawals, deposits, and balance inquiries. Despite their widespread use, traditional ATMs are typically limited in their ability to manage cash flow efficiently, particularly with respect to the handling, sorting, and redistribution of deposited currency. This inefficiency often leads to increased operational costs for financial institutions, including the need for frequent cash replenishment and manual cash handling by service personnel.

In response to these challenges, Automated Teller Recycler (ATR) machines have emerged as an innovative solution. ATRs integrate cash recycling capabilities into the traditional ATM framework. Unlike standard ATMs, ATRs are equipped with advanced mechanisms for verifying, sorting, and securely storing deposited banknotes. These stored banknotes can subsequently be reused for withdrawal transactions, effectively creating a closed-loop cash management system. This functionality reduces the frequency of cash replenishment, optimizes cash availability, and lowers the overall cost of operation.

Despite their advantages, the implementation of ATRs poses several challenges. For instance, ensuring the accurate authentication of deposited currency is critical to prevent the circulation of counterfeit banknotes. One technical challenge includes reliable mechanisms to pick bank notes from a stack, and to transport picked bank notes within an ATR. Devices and methods are described in the present disclosure that address these concerns, and other technical challenges.

### BRIEF DESCRIPTION OF THE DRAWINGS

FIG. 1 shows a schematic of an automatic teller machine in accordance with some example embodiments.

FIG. 2A shows a block diagram of a pocket of an automatic teller machine in accordance with some example embodiments.

FIG. 2B shows another block diagram of a pocket of an automatic teller machine in accordance with some example embodiments.

FIG. 3 shows an isometric view of a pusher plate of an automatic teller machine in accordance with some example embodiments.

FIG. 4 shows an isometric view of a stacking lever of an automatic teller machine in accordance with some example embodiments.

FIG. 5 shows an isometric view of selected components of a pocket assembly of an automatic teller machine in accordance with some example embodiments.

FIG. 6 shows an isometric view of selected components of a pocket assembly of an automatic teller machine in accordance with some example embodiments.

FIG. 7 shows a flow diagram of a method in accordance with some example embodiments.

### DESCRIPTION OF EMBODIMENTS

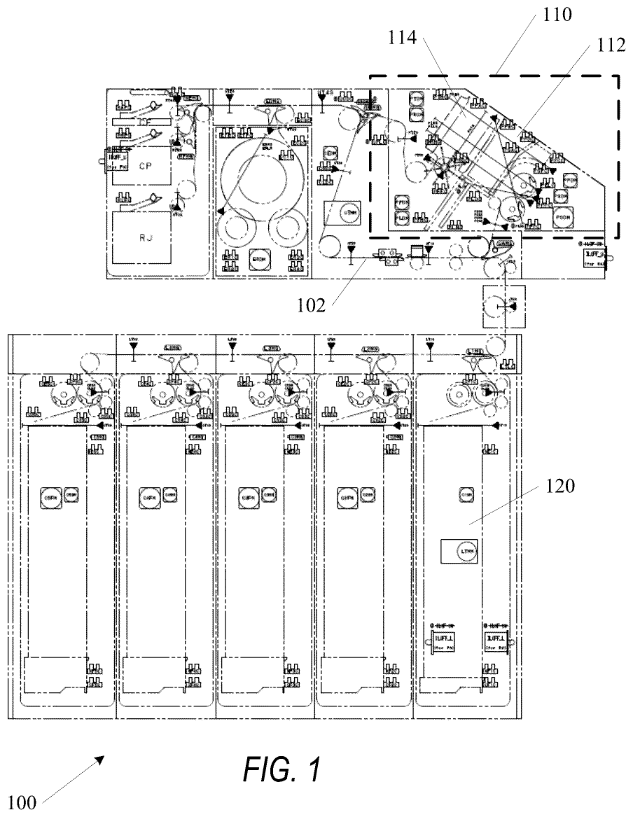

FIG. 1 shows an automatic teller machine 100 according to one example. The automatic teller machine 100 includes a pocket assembly 110. In the example of FIG. 1, the pocket assembly 110 is divided into a bottom compartment 112 and a top compartment 114. The pocket assembly 110 serves as the primary area for receiving and processing bank notes within the automatic teller machine 100. The bottom compartment 112 and the top compartment 114 are designed to facilitate the movement and storage of bank notes during various stages of a transaction process.

One or more note storage compartments 120 are shown. A belt 102 or other transport system is coupled between various components in the pocket assembly 110 and the note storage compartments 120. The note storage compartments 120 are connected to the pocket assembly 110 and provide a secure location for storing bank notes after they have been processed. The note storage compartment 120 ensures that bank notes are kept in an organized manner, ready for future transactions or for collection by authorized personnel. The connection between the pocket assembly 110 and the note storage compartment 120 allows for efficient transfer and storage of bank notes within the automatic teller machine 100.

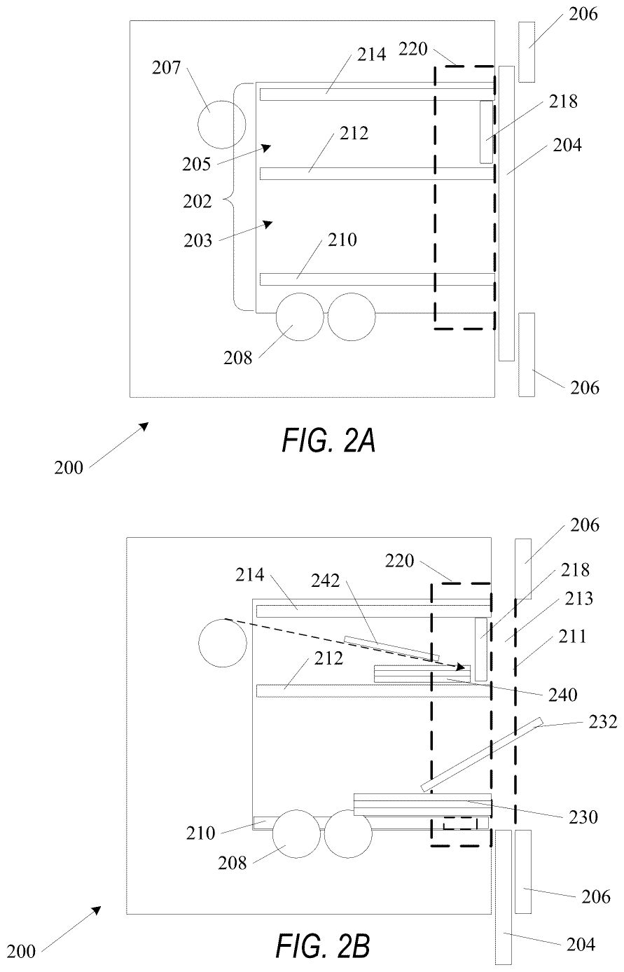

FIGS. 2A and 2B show a pocket assembly 200 similar to the pocket assembly 110 from FIG. 1. In FIG. 2A, a shutter 204 is shown in a closed position, covering a pocket 202. The pocket assembly 200 includes a pocket 202, which serves as the primary area for receiving bank notes. The fascia 206 is located on an exterior surface of the automatic teller machine, surrounding the pocket 202 and providing an interface for users. In the examples of FIGS. 2A and 2B, within the pocket 202, a stage plate 210 is shown, which is moveable up and down to facilitate the handling of bank notes.

Above the stage plate 210, a pusher plate 212 is located, which is also moveable up and down within the pocket 202 to press bank notes against the stage plate 210. A top plate 214 is positioned above the pusher plate 212. In one example, the top plate 214 is also moveable up and down within the pocket 202. On the side of the pocket 202, a side guide 220 is present, which aids in aligning bank notes within the pocket 202.

The stage plate 210 and the pusher plate 212 define a bottom compartment 203 between the stage plate 210 and the pusher plate 212, and a top compartment 205 between a top of the pocket 202 and the pusher plate 212. In one example, the bottom compartment 203 is configured to receive a stack of one or more received bank notes from a user, and the top compartment 205 is configured to receive any rejected items from the stack of one or more received bank notes. At least one top compartment roller 207 is shown, and configured to help route any rejected items from the stack of one or more received bank notes into the top compartment 205. Details of routing slots and additional rollers are omitted in FIGS. 2A and 2B for ease of illustration, however, one of ordinary skill in the art, having the benefit of the present disclosure, will recognize that additional structures and devices may be included to facilitate routing of bank notes, etc.

As noted above, in the position shown in FIG. 2A, the stage plate 210 and a pusher plate 212 define a bottom compartment 203, similar to the bottom compartment 112 from FIG. 1. In operation, a stack of bank notes 230 is inserted onto the stage plate 210 and the stage plate 210 is lowered as shown in FIG. 2B. One or more rollers 208 protrude through the stage plate 210 in FIG. 2B and are used to transport individual notes 232 within the automatic teller machine. In one example, the pusher plate 212 is also lowered to apply pressure to the stack of bank notes 230 while the rollers 208 engage the stack, although not shown in FIG. 2B.

In operation, a user may deposit the stack of bank notes 230 into the bottom compartment 203. Accepted bank notes may be routed to a storage compartment, such as storage compartment 120 from FIG. 1. Rejected bank notes (and/or other rejected items such as an inadvertent inclusion of a receipt) may be routed from the bottom compartment 203 to the top compartment 205 using at least top compartment roller 207. Rejected bank notes may include notes from a country that are not accepted at a given location for an automated teller machine. In one example, rejected bank notes are collected in the top compartment 205 for return to the user.

As shown in FIG. 2B, a stack of rejected bank notes 240 may be collected in the top compartment 205. An individual rejected bank note 242 is shown being directed towards a stacking lever 218 at a front side of the top compartment 205. Reliable and effective organization of rejected bank notes is desired. A design of the stacking lever 218 is shown that facilitates reliable and effective organization of rejected bank notes 240.

A slot 213 is further shown in FIGS. 2A and 2B to guide the shutter 204 between an extended position (shown in FIG. 2A) and a retracted position (shown in FIG. 2B). An edge of the slot 213 is shown by dashed line 211, and the slot 213 is located between the pocket 202 and the fascia 206 of the automatic teller machine.

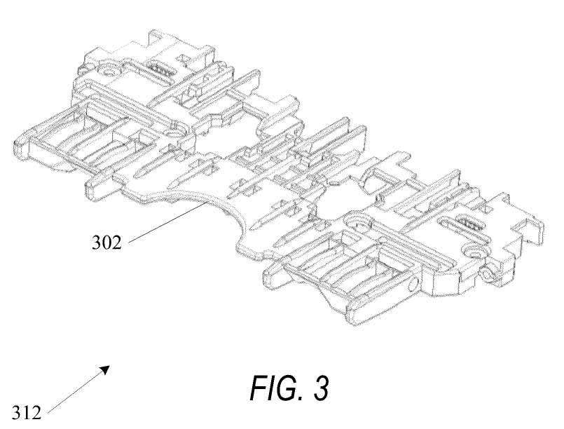

FIG. 3 shows a pusher plate 312 similar to pusher plate 212 from FIGS. 2A and 2B. In one example, the pusher plate 312 is integrally formed. Examples of integral formation include, but are not limited to, injection molding, CNC machining, 3D printing, etc. Integral formation provides lower cost manufacturing and improved reliability over multiple component configurations. In one example, the pusher plate 312 is integrally formed. In one example, the pusher plate 312 includes an integrally formed reinforced polymer. Reinforced polymer materials provide increased strength and toughness, and further provide improved reliability. Examples of reinforced polymers include glass fiber reinforcement, or other reinforcement materials. Glass reinforcement provides high strength and low cost. In one example, the pusher plate 312 includes an integrally formed injection molded reinforced polymer. Injection molding will be detectable in a final product. Examples of detectable physical features include, but are not limited to, flow orientation of polymer molecules and/or reinforcement fibers.

In one example, the pusher plate 312 includes a cutout 302 in a front portion to accommodate grasping stacked bank notes from below the cutout. In the example shown, the cutout 302 includes a semicircle, although the invention is not so limited. Other cutouts may include rectangles, ovals, triangles, etc. It is advantageous to include a cutout to accommodate grasping stacked bank notes in contrast to a folding flap or other separate component. Separate components are more prone to breaking. By including the cutout 302 in an integrally formed component, reliability is provided along with the functionality of an ability to accommodate grasping stacked bank notes.

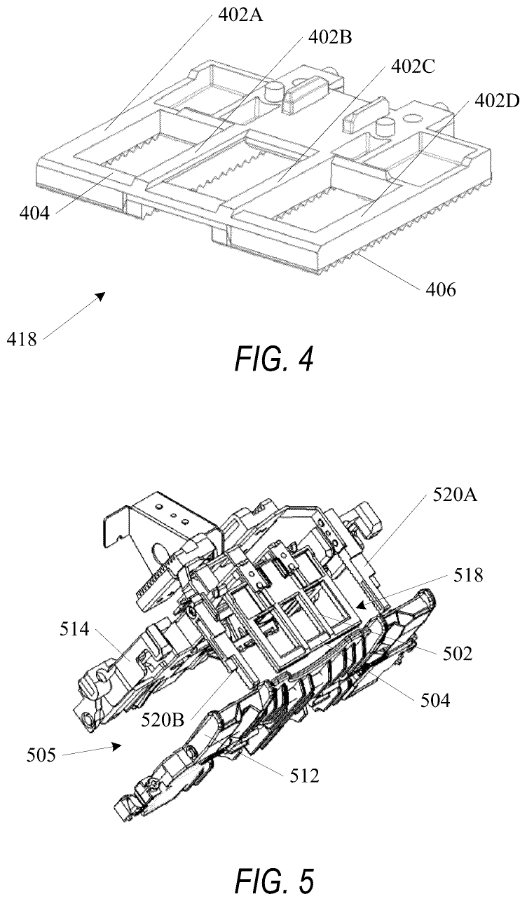

FIG. 4 shows an example of a stacking lever 418 similar to the stacking lever 218 from FIGS. 2A and 2B. In one example, the stacking lever 418 is integrally formed. Examples of integral formation include, but are not limited to, injection molding, CNC machining, 3D printing, etc. Integral formation provides lower cost manufacturing and improved reliability over multiple component configurations. In one example, the stacking lever 418 is integrally formed. In one example, the stacking lever 418 includes an integrally formed reinforced polymer. Reinforced polymer materials provide increased strength and toughness, and further provide improved reliability. Examples of reinforced polymers include glass fiber reinforcement, or other reinforcement materials. Glass reinforcement provides high strength and low cost. In one example, the stacking lever 418 includes an integrally formed injection molded reinforced polymer. Injection molding will be detectable in a final product. Examples of detectable physical features include, but are not limited to, flow orientation of polymer molecules and/or reinforcement fibers.

The stacking lever 418 in the example of FIG. 4 includes a plurality of integrally formed fingers 402A-D connected at an integrally formed lower edge 404. In the example of FIG. 4, the stacking lever 418 includes serrations 406 on a surface that, when in use, faces a pocket interior surface. The serrations 406 aid in aligning and stacking bank notes, as shown in the context of FIG. 2B. As individual rejected bank note 242 impacts the stacking lever, the serrations help to align the rejected bank note 242.

FIG. 5 shows selected components of a pocket assembly according to another example. A pusher plate 512 and a top plate 514 are shown that define a top compartment 505 similar to top compartment 205. A stacking lever 518 similar to stacking lever 418 from FIG. 4 is shown in context with the top compartment 505. A plurality of integrally formed fingers 502 are shown connected at an integrally formed lower edge 504. In the example of FIG. 5, additional outer fingers 520A and 520B are included adjacent to the stacking lever 518. The addition of outer fingers 520A and 520B further aids in aligning and stacking bank notes. In operation, after stacking of rejected bank notes in the top compartment 505, on top of the pusher plate 512, the stacking lever 518 is actuated towards a back side of the top compartment 505 to straighten the stack of rejected bank notes.

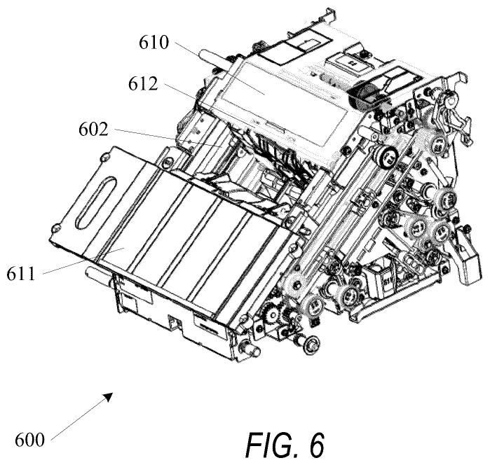

FIG. 6 shows additional selected components of a pocket assembly 600 according to another example. A pocket 602 is shown, with only a lower compartment visible. A top compartment is obscured by a top fascia cover 610. A bottom fascia cover 611 is also shown below the pocket 602. The top fascia cover 610 includes a bottom edge 612 that is straight, and continuous across the bottom edge 612. There are no notches that allow any view of rejected bank notes that are being collected in the obscured top compartment. If rejected bank notes are visible in the top compartment during a rejected bank note collection operation, a user may try to take the rejected bank notes before the automatic teller machine is ready to present them to the user. By obscuring the top compartment, the rejected bank notes can be collected undisturbed by the user until an appropriate time after all rejected bank notes are sorted in a sorting operation. At such a time, the pusher plate may be lowered in the pocket to return any rejected bank notes to the user.

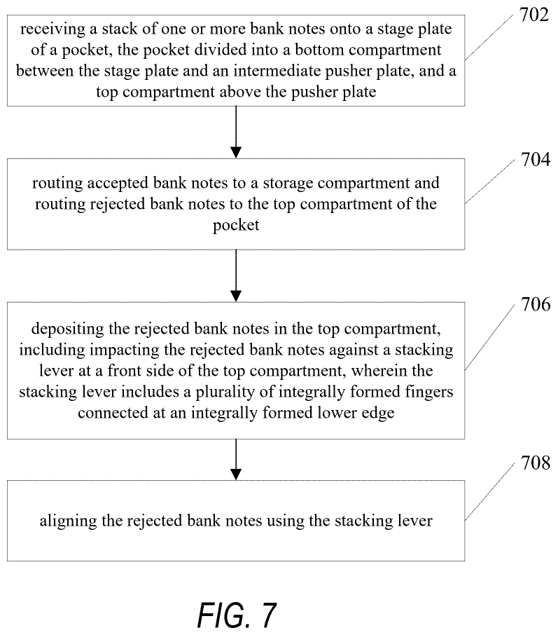

FIG. 7 shows a flow diagram of an example method of receiving bank notes in an automatic teller machine. In operation 702, a stack of one or more bank notes are received onto a stage plate of a pocket. The pocket is divided into a bottom compartment between the stage plate and an intermediate pusher plate, and a top compartment above the pusher plate. In operation 704, accepted bank notes are routed to a storage compartment and routing rejected bank notes to the top compartment of the pocket. In operation 706, the rejected bank notes are deposited in the top compartment, and the rejected bank notes impact against a stacking lever at a front side of the top compartment. The stacking lever includes a plurality of integrally formed fingers connected at an integrally formed lower edge. In operation 708, the rejected bank notes are aligned using the stacking lever.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

To better illustrate the method and apparatuses disclosed herein, a non-limiting list of embodiments is provided here:
Example 1. An automatic teller machine, comprising: a pocket to receive bank notes; a stage plate, wherein the stage plate is moveable up and down within the pocket in a range of motion; a pusher plate, wherein the pusher plate is moveable up and down within the pocket in the range of motion, wherein the pusher plate is integrally formed, and includes a cutout in a front portion to accommodate grasping stacked bank notes from below the cutout; the stage plate and the pusher plate defining a bottom compartment between the stage plate and the pusher plate, and a top compartment between a top of the pocket and the pusher plate, the bottom compartment configured to receive a stack of one or more received bank notes from a user, and the top compartment configured to receive any rejected items from the stack of one or more received bank notes; a stacking lever in a front portion of the top compartment, the stacking lever including a plurality of integrally formed fingers connected at an integrally formed lower edge.
Example 2. The automatic teller machine of example 1, wherein the stacking lever includes an integrally formed reinforced polymer.
Example 3. The automatic teller machine of example 2, wherein the stacking lever includes an integrally formed injection molded reinforced polymer.
Example 4. The automatic teller machine of example 3, wherein the stacking lever includes four integrally formed fingers connected at the lower edge.
Example 5. The automatic teller machine of example 4, wherein the stacking lever includes serrations on a pocket interior surface.
Example 6. The automatic teller machine of example 1, wherein the pusher plate includes an integrally formed reinforced polymer.
Example 7. The automatic teller machine of example 6, wherein the pusher plate includes an integrally formed injection molded reinforced polymer.
Example 8. The automatic teller machine of example 7, wherein the cutout in the pusher plate includes a semicircle cutout.
Example 9. The automatic teller machine of example 1, wherein the top compartment is obscured from view during a sorting operation where any rejected items from the stack of one or more received bank notes are routed from the bottom compartment to the top compartment.
Example 10. A method of receiving bank notes in an automatic teller machine, comprising: receiving a stack of one or more bank notes onto a stage plate of a pocket, the pocket divided into a bottom compartment between the stage plate and an intermediate pusher plate, and a top compartment above the pusher plate; routing accepted bank notes to a storage compartment and routing rejected bank notes to the top compartment of the pocket; depositing the rejected bank notes in the top compartment, including impacting the rejected bank notes against a stacking lever at a front side of the top compartment, wherein the stacking lever includes a plurality of integrally formed fingers connected at an integrally formed lower edge; and aligning the rejected bank notes using the stacking lever.
Example 11. The method of example 10, further including moving the stage plate to a lower portion of the pocket to expose one or more rollers through the stage plate.
Example 12. The method of example 11, further including moving the pusher plate to a lower portion of the pocket to expose the one or more rollers through the pusher plate.
Example 13. The method of example 10, wherein depositing the rejected bank notes in the top compartment includes depositing in a top compartment that is obscured from a user during the depositing operation.
Example 14. The method of example 10, wherein impacting the rejected bank notes against a stacking lever includes impacting against one or more serrations.
Example 15. The method of example 10, wherein depositing the rejected bank notes in the top compartment includes depositing onto the pusher plate, wherein the pusher plate is integrally formed from a reinforced polymer.
Example 16. The method of example 15, further including retrieving rejected notes from the integrally formed pusher plate, including grasping rejected bank notes through a cutout in the integrally formed pusher plate.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. An automatic teller machine, comprising:
a pocket to receive bank notes;
a stage plate, wherein the stage plate is moveable up and down within the pocket in a range of motion;
a pusher plate, wherein the pusher plate is moveable up and down within the pocket in the range of motion, wherein the pusher plate is integrally formed, and includes a cutout in a front portion to accommodate grasping stacked bank notes from below the cutout;
the stage plate and the pusher plate defining a bottom compartment between the stage plate and the pusher plate, and a top compartment between a top of the pocket and the pusher plate, the bottom compartment configured to receive a stack of one or more received bank notes from a user, and the top compartment configured to receive any rejected items from the stack of one or more received bank notes;
a stacking lever in a front portion of the top compartment, the stacking lever including a plurality of integrally formed fingers connected at an integrally formed lower edge.

2. The automatic teller machine of claim 1, wherein the stacking lever includes an integrally formed reinforced polymer.

3. The automatic teller machine of claim 2, wherein the stacking lever includes an integrally formed injection molded reinforced polymer.

4. The automatic teller machine of claim 3, wherein the stacking lever includes four integrally formed fingers connected at the lower edge.

5. The automatic teller machine of claim 4, wherein the stacking lever includes serrations on a pocket interior surface.

6. The automatic teller machine of claim 1, wherein the pusher plate includes an integrally formed reinforced polymer.

7. The automatic teller machine of claim 6, wherein the pusher plate includes an integrally formed injection molded reinforced polymer.

8. The automatic teller machine of claim 7, wherein the cutout in the pusher plate includes a semicircle cutout.

9. The automatic teller machine of claim 1, wherein the top compartment is obscured from view during a sorting operation where any rejected items from the stack of one or more received bank notes are routed from the bottom compartment to the top compartment.

10. A method of receiving bank notes in an automatic teller machine, comprising:
receiving a stack of one or more bank notes onto a stage plate of a pocket, the pocket divided into a bottom compartment between the stage plate and an intermediate pusher plate, and a top compartment above the pusher plate;
routing accepted bank notes to a storage compartment and routing rejected bank notes to the top compartment of the pocket;
depositing the rejected bank notes in the top compartment, including impacting the rejected bank notes against a stacking lever at a front side of the top compartment, wherein the stacking lever includes a plurality of integrally formed fingers connected at an integrally formed lower edge; and
aligning the rejected bank notes using the stacking lever.

11. The method of claim 10, further including moving the stage plate to a lower portion of the pocket to expose one or more rollers through the stage plate.

12. The method of claim 11, further including moving the pusher plate to a lower portion of the pocket to expose the one or more rollers through the pusher plate.

13. The method of claim 10, wherein depositing the rejected bank notes in the top compartment includes depositing in a top compartment that is obscured from a user during the depositing operation.

14. The method of claim 10, wherein impacting the rejected bank notes against a stacking lever includes impacting against one or more serrations.

15. The method of claim 10, wherein depositing the rejected bank notes in the top compartment includes depositing onto the pusher plate, wherein the pusher plate is integrally formed from a reinforced polymer.

16. The method of claim 15, further including retrieving rejected notes from the integrally formed pusher plate, including grasping rejected bank notes through a cutout in the integrally formed pusher plate.
